(19) United States
(12) Patent Application Publication
(10) Pub. No.: US 2006/0056900 A1
(43) Pub. Date: Mar. 16, 2006

(54) Label conveying apparatus and label printer having the same

(76) Inventor: Toshiharu Itakura, Chiba-shi (JP)

Correspondence Address: BRUCE L. ADAMS, ESQ., 17 BATTERY - PLACE-SUITE 1231, NEW YORK, NY, 10004, US

(21) Appl. No.: 11/196,097

(22) Filed: Aug. 3, 2005

(30) Foreign Application Priority Data
Sep. 14, 2004 (JP) 2004-267451

(51) Int. Cl. B41F 15/04

(52) U.S. Cl. 400/611

(57) ABSTRACT

A motor (7) rotates a platen roller (3) so as to convey a continuous label sheet (1) drawn out from a roll member (2). A thermal head (4) generates heat at an appropriate timing in synchronism with the conveyance, thereby effecting recording on an adhesive label (1). The continuous label sheet (1) that has undergone recording is deflected along the outer periphery of a peeler bar (5), causing an adhesive label (1a) to peel off from a peeling paper (1b). The peeling paper (1b) from which the adhesive label (1a) has been peeled off reaches the outer periphery of a peeling paper conveying roller (6). Torque is transmitted via an accelerating wheel train composed of a platen roller driving gear (3b) and a conveying roller driving gear (6b), whereby the peeling paper conveying roller (6) conveys the peeling paper (1b) at a greater conveying capacity than the platen roller (3). The continuous label sheet (1) (peeling paper (1b)) advances while being constantly applied with a force pulling it from the leading edge side (downstream side), whereby no slack develops in the continuous label sheet (1) as it is conveyed.

### BACKGROUND OF THE INVENTION

1. Field of the Invention

The present invention relates to a label conveying apparatus for manufacturing an adhesive label and to a label printer having the label conveying apparatus.

2. Description of the Related Art

Adhesive labels having desired letters, numbers, symbols, and the like printed on their non-adhesive surface are conventionally used in order, for example, to indicate the price, name, and the like of each merchandise item in stores or to indicate the type and the like of items stored in warehouses. Adhesive labels of this type are manufactured by using label printers, with which a plurality of adhesive labels are temporarily adhered to a single peeling paper to prepare a continuous label sheet, and after the continuous label sheet is conveyed to a recording head and printing is effected on the non-adhesive surface of each adhesive label, the adhesive labels are peeled off from the peeling paper by a peeling mechanism including a peeler bar and the like for affixing onto each merchandise item or the like. As disclosed in JP 6-40443 A and JP 2004-115041 A, such a label printer is provided with a platen roller for conveying a continuous label sheet with adhesive labels temporarily adhered thereto to a recording head and a peeling mechanism, and a peeling paper conveying roller for collecting and/or discharging the peeling paper from which the adhesive labels that have undergone printing have been peeled off.

JP 6-40443 A provides no particular description as to the correlation between the platen roller, which conveys the continuous label sheet with the adhesive labels temporarily adhered thereto, and the peeling paper conveying roller, which conveys the peeling paper from which the adhesive labels have been peeled off. In the case where the platen roller and the peeling paper conveying roller are individually driven by independent drive means (such as a motor), two conveyor drive means exist within the label printer, resulting in increases in the size and weight of the apparatus and an increase in its power consumption. In the case where, as described above, the adhesive labels are subjected to printing and peeling one by one for affixing onto a target object in stores and warehouses, if the label printer can be carried about by the working personnel during such a work, this realizes excellent workability and proves highly efficient. Accordingly, portable label printers are preferred, and for this reason there is a demand for reductions in the size and weight of label printers. Furthermore, there is also a demand for a reduction in power consumption to a level allowing the label printer to be driven by using a battery.

As shown in FIG. 4, in the label printer described in JP 2004-115041 A, the outer periphery of a peeling paper conveying roller 100 is brought into press contact with the outer periphery of a platen roller 101, thereby transmitting torque from the platen roller 101 to the peeling paper conveying roller 100. According to this construction, both the platen roller 101 and the peeling paper conveying roller 100 are rotated by a single drive means 102, making it possible to achieve a decrease in the size and weight of the label printer and a reduction in the power consumption of the same.

In the label printer disclosed in JP 2004-115041 A, the platen roller 101 and a thermal head 103 are opposed to each other, and a continuous label sheet 104 is conveyed while pressurized against the platen roller 101 and the thermal head 103. On the other hand, a peeling paper 104b from which an adhesive label 104a has been peeled off is conveyed while passing between the peeling paper conveying roller 100 and the platen roller 101.

With this construction, in order to perform recording on the adhesive label 104a with good precision, the thermal head 103 conveys the continuous label sheet 104 while securely sandwiching and holing the continuous label sheet 104 between the thermal head 103 and the platen roller 101 so as to prevent positional displacement of the adhesive label 104a. The continuous label sheet 104 is thus reliably conveyed at a predetermined conveyance speed without slippage. Moreover, the platen roller 101 is coupled to the drive means 102 through the intermediation of a gear group (not shown), whereby predetermined torque is transmitted to the platen roller 101 without causing a large slip in the drive mechanism for the platen roller 101.

In contrast, the peeling paper conveying roller 100 gains torque through the frictional contact between the peeling paper conveying roller 100 and the platen roller 101; when the peeling paper 104b is inserted in between the peeling paper conveying roller 100 and the platen roller 101, a slip occurs among three component parts that are the platen roller 101, the peeling paper 104b, and the peeling paper conveying roller 100, with the result that the torque of the platen roller 101 is not transmitted to the peeling paper conveying roller 100 in a satisfactory manner and thus the peeling paper conveying roller 100 does not rotate at a predetermine rpm, which may cause a decrease in the conveyance rate of the peeling paper 104b. Normally, the outer periphery of each of the platen roller 101 and the peeling paper conveying roller 100 is formed of a smooth elastic member such as rubber which in many cases does not generate a frictional force large enough to prevent a slip between it and the peeling paper 104b. Since it has conventionally been considered that the peeling paper 104b from which the adhesive label 104a has been peeled off may simply be collected and/or discharged so as not to interfere with other members, no particular attention has been paid to the conveyance speed of the peeling paper 104b, that is, the conveying rate of the peeling paper conveying roller 100.

According to such a construction, however, while the continuous label sheet 104 prior to peeling is reliably conveyed at a predetermined conveyance rate, the peeling paper 104b after the peeling can only be conveyed at a low conveyance rate due to slippage. As a result, as shown in FIG. 4, slack may develop in the peeling paper 104b at some point of the conveyance path extending from the thermal head 103 to the peeling paper conveying roller 100. In particular, slack is liable to develop in the peeling paper 104b at a position in the vicinity of the peeling mechanism (peeler bar 105) where the peeling paper 104b is deflected to allow peeling of the adhesive label 104a. When slack thus develops in the peeling paper 104b, the peeling paper 104b cannot be deflected at a predetermined angle within the peeling mechanism, whereby it becomes difficult to reliably peel off the adhesive label 104a and peeling errors may occur. Further, jamming may occur in the continuous label sheet 104 due to such reasons as the interference of the slacked portion of the peeling paper 104b with a guide member, the inner wall of an opening portion, or the like. When a peeling error or jamming occurs, recovery from such a situation must be performed through manual operation by the working personnel, which leads to a decrease in the working efficiency. Furthermore, since there exists no effective measure for preventing the subsequent occurrences of a peeling error or jamming, the reliability of successful preparation of a desired adhesive label 104a is low.

In particular, in the case of the continuous label sheet 104 having a construction in which a large number of adhesive labels 104a are temporarily adhered to the peeling paper 104b that is in the form of a single sheet, the adhesive labels 104a must be peeled off one after another by the peeler bar 105; once slack develops in the peeling paper 104b, the continuous label sheet 104 cannot be deflected at a desired angle, with the result peeling of all the succeeding adhesive labels 104a becomes difficult.

In view of the above problems, it is an object of the present invention to provide a label conveying apparatus with which no slack develops in the continuous label sheet or the peeling paper and which is capable of peeling off the adhesive label with high reliability and effecting conveyance of the same with high precision at a predetermined conveyance rate, and a label printer having the label conveying apparatus.

### SUMMARY OF THE INVENTION

A label conveying apparatus according to the present invention includes: a platen roller for conveying a continuous label sheet, the continuous label sheet including an adhesive label temporarily adhered to a continuous-sheet-like peeling paper; a peeling mechanism for peeling off the adhesive label from the peeling paper; and a peeling paper conveying roller to which torque from the platen roller is transmitted, for conveying the peeling paper from which the adhesive label is peeled off by the peeling mechanism at a conveying capacity larger than a conveying capacity of the platen roller. The peeling paper conveying roller serves to convey the continuous label sheet at a conveying capacity allowing the continuous label sheet being conveyed to be constantly applied with a force acting to pull the continuous label sheet toward a downstream side in a conveying direction. This construction prevents the continuous label sheet from stalling on the leading edge side (downstream side) to develop slack, whereby the continuous label sheet can be smoothly conveyed to suppress peeling errors or jamming of the adhesive label.

When torque is transmitted to the peeling paper conveying roller from the platen roller via gears meshing with each other, no slip occurs between the peeling paper conveying roller and the platen roller, making it possible to effect driving force transmission with high reliability.

The gears through which the torque is transmitted from the platen roller to the peeling paper conveying roller may constitute an accelerating wheel train. In that case, even when the platen roller and the peeling paper conveying roller are of substantially the same construction, it is possible to impart the peeling paper conveying roller with an rpm and a conveying capacity larger than those of the platen roller.

Further, the peeling paper conveying roller may have a diameter larger than that of the platen roller. In that case, it is possible to impart the peeling paper conveying roller with a peripheral speed and a conveying capacity larger than those of the platen roller even when the torque transmitting gears are not an accelerating wheel train.

The peeling paper conveying roller is preferably provided with a one-way clutch mechanism allowing the peeling paper conveying roller to rotate only in the conveying direction of the peeling paper. In that case, no slack develops even when, for example, the continuous label sheet is fed in the reverse direction for the purpose of effecting positional alignment on the printing start position.

The peeling mechanism used maybe one which, when the continuous label sheet having a plurality of the adhesive labels temporarily adhered to the peeling paper while being arranged side by side in the conveying direction is supplied, successively peels off the plurality of the adhesive labels from the peeling paper.

A label printer according to the present invention includes the conveying apparatus having any one of the constructions described above, and a recording head that sandwiches the continuous label sheet between the recording head and the platen roller, for performing recording on a non-adhesive surface of the adhesive label.

According to the present invention, the occurrence of slack in the continuous label sheet can be suppressed to enable smooth conveyance of the continuous label sheet, whereby peeling errors or jamming of the adhesive label can be suppressed.

### BRIEF DESCRIPTION OF THE DRAWINGS

In the accompanying drawings:

FIG. 1 is a schematic main portion view showing an inner portion of a label printer according to a first embodiment of the present invention;

FIG. 2 is an enlarged view showing a one-way clutch mechanism of the label printer shown in FIG. 1;

FIG. 3 is a schematic main portion view showing an inner portion of a label printer according to a second embodiment of the present invention; and

FIG. 4 is a schematic main portion view showing an inner portion of a conventional label printer.

### DESCRIPTION OF THE PREFERRED EMBODIMENTS

Hereinbelow, embodiments of the present invention are described with reference to the drawings.

### First Embodiment

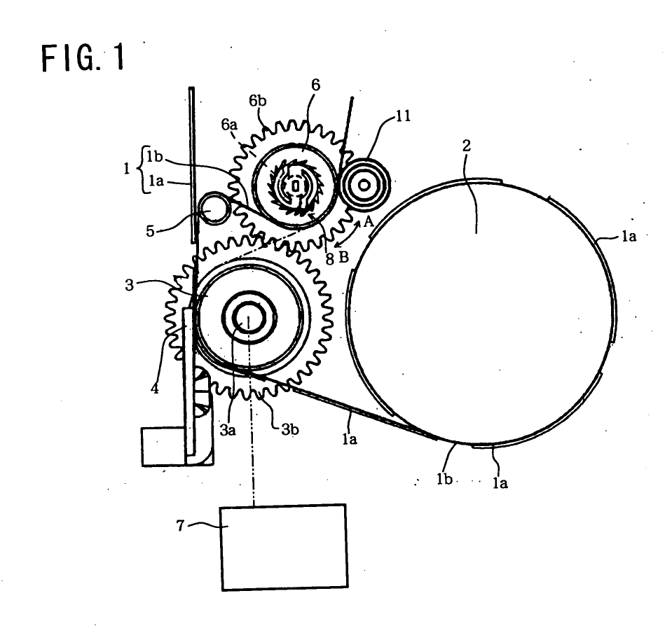

FIG. 1 is a schematic main portion view of the inner portion of a casing (not shown) of a label printer having a label conveying apparatus according to a first embodiment of the present invention. Now, the basic construction of the label printer is described. The label printer includes, inside the casing (not shown): a holding portion for a roll member 2 around which a continuous label sheet 1 is wound; a platen roller 3 for successively drawing out the continuous sheet 1 from the roll member 2; a thermal head 4 opposed in close proximity to the platen roller 3, for recording letters, numbers, symbols, and the like on a non-adhesive surface of an adhesive label 1a of the continuous label sheet 1; a small-diameter peeler bar (peeling mechanism) 5 for deflecting the continuous label sheet 1 having passed the gap between the platen roller 3 and the thermal head 4 to thereby peel off the adhesive label 1a that has undergone recording from a peeling paper 1b ; a peeling paper conveying roller 6 for conveying the peeling paper 1b from which the adhesive label 1a has been peeled off by the peeler bar 5; and an idler roller 11 driven by the peeling paper conveying roller 6.

Further, a platen roller driving gear 3b is mounted coaxially to a center shaft 3a of the platen roller 3, and a conveying roller driving gear 6b is mounted coaxially to a center shaft 6a of the peeling paper conveying roller 6 through the intermediation of a one-way clutch mechanism 8 that is described later. A motor 7 as a driving means is connected to the platen roller driving gear 3b through the intermediation of a gear train (not shown). Further, the platen roller driving gear 3b and the conveying roller driving gear 6b are in direct mesh with each other, and the conveying roller driving gear 6b is smaller in diameter than the platen roller driving gear 3b. That is, there is formed a group of gears for transmitting torque from the motor 7 to the conveying roller driving gear 6b via the platen roller driving gear 3b, with the portion from the platen roller driving gear 3b to the conveying roller driving gear 6b constituting an accelerating wheel train for accelerating the rpm as the torque is transmitted. Accordingly, due to the accelerating wheel train, the conveying roller driving gear 6b tends to rotate at a greater rpm than the platen roller driving gear 3b. In other words, the conveying roller driving gear 6b exhibits a greater conveyance capacity as it rotates than the platen roller driving gear 3b. The peeling paper conveying roller 6 is urged by an urging means (not shown) so as to apply an appropriate load to the peeling paper 1b and actuate the one-way clutch mechanism 8 described later in a favorable manner.

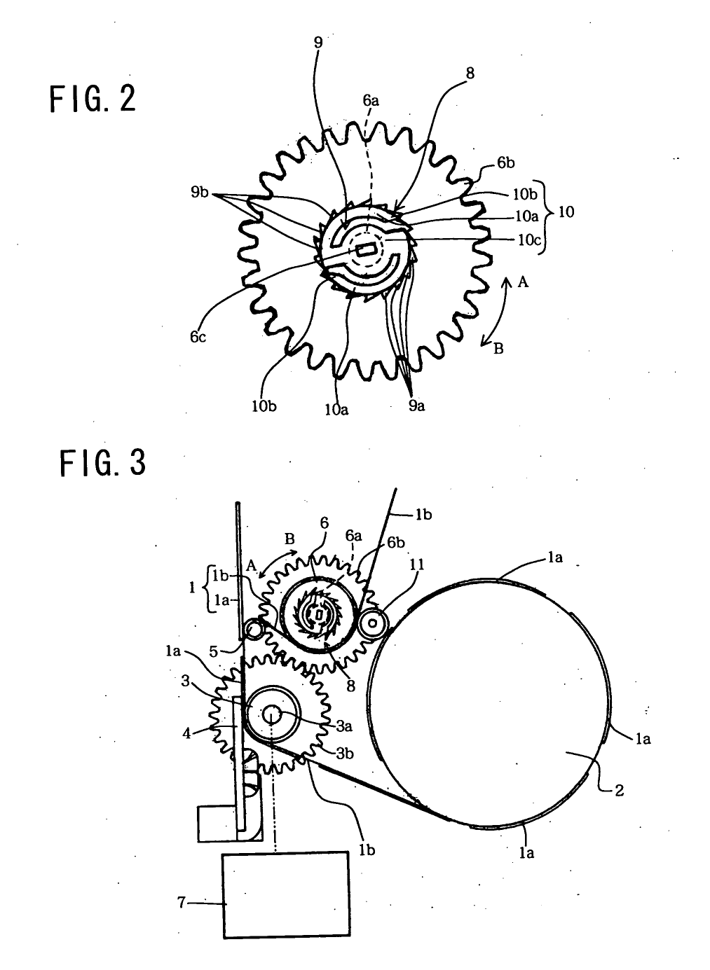

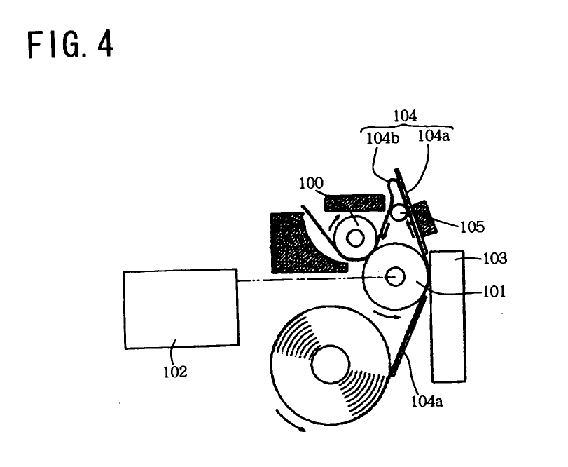

The one-way clutch mechanism 8 is built in the peeling paper conveying roller 6. The one-way clutch mechanism 8 is now described with reference to FIG. 2. Provided over the entire inner periphery of a hole portion 9 provided at the center of the conveying roller driving gear 6b are a plurality of engaging recesses 9a each cut out obliquely in one direction. Further, a ratchet wheel 10, which is fixed to a rectangular end portion 6c of the center shaft 6a, is inserted in the hole portion 9. The ratchet wheel 10 has a plurality of elastically deformable arm portions 10a extending from a center portion 10c fixed to the center shaft 6a, and each of the arm portions 10a has at its distal end a claw portion 10b capable of engaging each engaging recess 9a. Accordingly, when torque in the forward direction (the arrow A direction) is transmitted to the conveying roller driving gear 6b, the claw portion 10b of each arm portion 10a is fitted in the corresponding engaging recess 9a and does not dislodge therefrom, whereby the ratchet wheel 10 rotates integrally with the conveying roller driving gear 6b, causing the center shaft 6a and the peeling paper conveying roller 6 also to rotate integrally.

However, when torque in the reverse direction (the arrow B direction) is transmitted to the conveying roller driving gear 6b, each arm portion 10a undergoes slight elastic deformation, with its claw portion 10b sliding along a gentle incline portion 9b of the corresponding engaging recess 9a before exiting the engaging recess 9a. Accordingly, the claw portion 10b passes the gentle incline portions 9b of the respective engaging recesses 9a one after another without being fixed in one engaging recess 9a, causing the ratchet wheel 10 to rotate relatively inside the hole portion 9. That is, even when torque in the reverse direction (the arrow B direction) is transmitted to the conveying roller driving gear 6b and the conveying roller driving gear 6b rotates, the ratchet wheel 10 does not rotate, and the center shaft 6a and the peeling paper conveying roller 6, which operate integrally with the ratchet wheel 10, also do not rotate and remain at rest. The one-way clutch mechanism 8 is thus constructed, according to which the peeling paper conveying roller 6, which is applied with an appropriate urging force by the urging means (not shown), is able to rotate only in the forward direction and not able to rotate in the reverse direction.

The peeler bar 5 is located on the outside (the upper left side in the drawing) with respect to the line (indicated by the alternate long and short dash line in the drawing) connecting the outer periphery of the platen roller 3 and the outer periphery of the peeling paper conveying roller 6. The peeler bar 5 serves to locally deflect the conveyance path extending to the peeling paper conveying roller 6 from the platen roller 3. Specifically, in this embodiment, the continuous label sheet 1 is deflected at an angle of approximately 60 degrees around the peeler bar 5 as it is conveyed from the outer periphery of the platen roller 3 and reaches the outer periphery of the peeling paper conveying roller 6 via the peeler bar 5. In order to maintain such deflection, it is also possible to provide a guide member (not shown) and to construct the peeling mechanism from the guide member and the peeler bar 5.

It should be noted that the continuous label sheet 1 used in this embodiment is formed by arranging a large number of adhesive labels 1a side by side in the longitudinal direction of the peeling paper 1b, which is in the form of a single continuous sheet, and temporarily adhering them to the peeling paper 1b. As the continuous label sheet 1 is paid out from the roll member 2, the individual adhesive labels 1a are drawn out one by one in order. The adhesive label 1a is a heat sensitive paper which, when heated, develops color at its heated portion. It should be noted that the details on the inner portion of the roll member 2 are not shown in the drawings.

Now, a method of manufacturing a desired adhesive label 1a according to the above-described construction is described.

First, although detailed description is not given, the leading edge of the continuous label sheet 1 is drawn out from the roll member 2 and set in position by using the guide member (not shown) or the like. Then, the motor 7 activates to rotationally drive the platen roller 3, thereby conveying the continuous label sheet 1. When the continuous label sheet 1 reaches the gap between the platen roller 3 and the thermal head 4, the non-adhesive surface of the adhesive label 1a and the peeling paper 1b are brought into press contact with the thermal head 4 and the platen roller 3, respectively. Then, after positional alignment on the printing start position of the adhesive label 1a, a suitable portion of the thermal head 4 generates heat at suitable timing in synchronism with the conveyance of the continuous label sheet 1, whereby letters, numbers, symbols, and the like are recorded as desired onto the non-adhesive surface of the adhesive label 1.

As it is further conveyed, the continuous label sheet 1 reaches the peeler bar 5. The continuous label sheet 1 is deflected as it is wound onto the outer periphery of the peeler bar 5, whereby the adhesive label 1a is peeled off from the peeling paper 1b. That is, while the peeling paper 1b in contact with the peeler bar 5 advances while undergoing deflection along the outer periphery of the peeler bar 5, the adhesive label 1a located on the side not in contact with the peeler bar 5 moves straight ahead without moving along the outer periphery of the peeler bar 5 due to its rigidity (so-called “stiffness”) and is thus peeled off from the peeling paper 1b. Note that, although not shown, an opening is provided in the vicinity of the peeler bar 5 (upper side in the drawing); the adhesive label 1a thus peeled off projects to the exterior of the casing through the opening, allowing easy removal by the user on the outside of the casing.

The peeling paper 1b from which the adhesive label 1a has thus been peeled off reaches the outer periphery of the peeling paper conveying roller 6. The rotation drive force generated by the motor 7 rotates the platen roller 3 through the intermediation of the platen roller driving gear 3b and, at the same time, is transmitted to the conveying roller driving gear 6b in mesh with the platen roller driving gear 3b, thereby causing the peeling paper conveying roller 6 to rotate. Since the direction of the torque transmitted to the conveying roller driving gear 6b is the forward direction (the arrow A direction) at this time, the conveying roller driving gear 6b, the center shaft 6a, and the peeling paper conveying roller 6 rotate integrally together. As the peeling paper conveying roller 6 is thus rotated, the peeling paper 1b is conveyed while passing between the peeling paper conveying roller 6 and the idler roller 11.

In this embodiment, the conveying roller driving gear 6b is connected to the platen roller driving gear 3b through the intermediation of the accelerating wheel train, whereby the peeling paper conveying roller 6 exhibits a greater conveying capacity than the platen roller 3 in conveying the peeling paper 1b. In other words, the conveying capacity of the peeling paper conveying roller 6 located on the downstream side with respect to the conveying direction of the continuous label sheet 1 (peeling paper 1b ) is greater than the conveying capacity of the platen roller 3 located on the upstream side. Accordingly, as it advances, the continuous label sheet 1 (peeling paper 1b ) is constantly applied with a force pulling it from the leading edge side (downstream side). As a result, no excess continuous label sheet 1 portion is produced at the intermediate portion, e.g. in the vicinity of the peeler bar 5, whereby no slack develops and the conveyance of the continuous label sheet 1 can be performed in a stable manner without causing peeling errors or jamming.

The specific behaviors of the continuous label sheet 1 are described in more detail. According to this embodiment, the portion of the continuous label sheet 1 sandwiched between the platen roller 3 and the thermal head 4 is brought into firm press contact so as to prevent positional displacement and ensure high-accuracy recording. No slippage of the continuous label sheet 1 occurs at this portion, allowing the continuous label sheet 1 to be conveyed in synchronism with the rotation of the platen roller 3. In contrast, the press-contact force acting on the portion of the continuous label sheet 1 sandwiched between the peeling paper conveying roller 6 and the idler roller 11 is small as compared with that acting on the portion sandwiched between the platen roller 3 and the thermal head 4. The peeling paper 1b thus undergoes slight slipping at the portion sandwiched between the peeling paper conveying roller 6 and the idler roller 11 as the continuous label sheet 1 is conveyed. When the continuous label sheet 1 is conveyed in the manner described above, it is often the case with the prior art that the continuous label sheet 1 stalls on the leading edge side (downstream side) where slip occurs between the continuous label sheet 1 and the peeling paper conveying roller 6 while advancing at a predetermined speed on the trailing portion side (upstream side) in press contact with the platen roller 3, with the result that an excess continuous label sheet 1 portion is produced between the two sides, developing slack in the vicinity of the peeler bar 5, for example. According to this embodiment, in contrast, the conveying capacity of the peeling paper conveying roller 6 is large so that the continuous label sheet 1 undergoes only the minimum slippage necessary for keeping the speed of the continuous label sheet 1 constant between the leading edge side and the trailing portion side, whereby the continuous label sheet 1 does not stall to develop slack as is the case with the prior art.

Although it may seem that slack can be in theory prevented if the conveying capacities of the platen roller 3 and the peeling paper conveying roller 6 are exactly the same; in practice, however, the continuous label sheet 1 moves at a speed that is, albeit slightly, lower on the leading edge side than on the trailing portion side due to the slip of the continuous label sheet 1, the plays of the both gears 3b and 6b, and the like, which may cause small slack. Such small slack, when accumulated over time, may eventually develop into one large enough to cause peeling errors or jamming. In view of this, in this embodiment, the conveying capacity of the peeling paper conveying roller 6 is deliberately set larger than the conveying capacity of the platen roller 3.

The term “conveying capacity” as used herein refers to the speed at which a sheet that is not being restrained by another member or the like is conveyed by a roller; in this embodiment, while also taking into account the sheet retention force by the roller outer periphery, the peeling paper conveying roller 6 is endowed with a conveying capacity large enough to constantly apply to the continuous label sheet 1 being conveyed a pulling force with which the continuous label sheet 1 is pulled toward the leading edge side (downstream side). It should be noted, however, that the conveying capacity is restricted to be of such a magnitude as not to break the continuous label sheet 1 between the peeling paper conveying roller 6 and the platen roller 3.

Upon completing the printing on and peeling of one adhesive label 1a as described above, printing on and peeling of the next adhesive label 1a are performed. In the case where printing and peeling are to be successively performed on multiple adhesive labels la, printing can be performed on the next adhesive label 1a in the middle of performing peeling of the preceding adhesive label 1a. However, in the case where operation is temporarily stopped once the printing on and peeling of the preceding adhesive label 1a are complete and then thereafter printing on and peeling of the next adhesive label 1a are performed again, there is a possibility that a part of the next adhesive label 1a may have already passed the position opposed to the thermal head 4 at the time when the peeling of the preceding adhesive label 1a has been performed. In that case, in order to effect positional alignment on the printing start position of the next adhesive label 1a with respect to the thermal head 4, the motor 7 is driven to rotate in reverse, whereby the platen roller driving gear 3b and the platen roller 3 are rotated in reverse to move the continuous label sheet 1 backward. At this time, the conveying roller driving gear 6b in meshing engagement with the platen roller driving gear 3b also makes reverse rotation in the arrow B direction; however, the peeling paper conveying roller 6 is not driven due to the action of the one-way clutch mechanism 8.

Assuming that no one-way clutch mechanism 8 exists, the peeling paper conveying roller 6 will rotate in reverse in the arrow B direction together with the conveying roller driving gear 6b. Since, as described above, the peeling paper conveying roller 6 has a greater conveying capacity than the platen roller 3, with regard to the conveying direction of the continuous label sheet 1 (the direction reverse to the normal conveying direction) in this case, the conveyance rate becomes larger on the trailing portion side than on the leading edge side. As a result, an excess continuous label sheet 1 portion is produced between the peeling paper conveying roller 6 and the platen roller 3, causing slack in the vicinity of the peeler bar 5, for example. This slack becomes the cause of peeling errors of the adhesive label 1a or the jamming of the continuous label sheet 1.

According to this embodiment, in contrast, due to the action of the one-way clutch mechanism 8, the peeling paper conveying roller 6 does not rotate even during backward movement of the continuous label sheet 1 or, even if it does, the peeling paper conveying roller 6 makes only slight reverse rotation following the movement of the continuous label sheet 1; at the very least, the conveying rate of the peeling paper conveying roller 6 never becomes larger than that of the platen roller 3. Accordingly, no excess continuous label sheet 1 portion is produced between the peeling paper conveying roller 6 and the platen roller 3, and hence no slack occurs.

As described above, according to this embodiment, the occurrence of slack is restrained both during the advancing movement of the continuous label sheet 1 in the forward direction and the backward movement thereof in the reverse direction, whereby the continuous label sheet 1 can be conveyed in a smooth manner while preventing peeling errors or jamming.

### Second Embodiment

Next, a second embodiment of the present invention is described with reference to FIG. 3. It should be noted that the portions identical to those of the first embodiment are denoted by the same reference symbols and detailed description thereof is omitted.

In a label printer having a label conveying apparatus according to this embodiment, the platen roller driving gear 3b and the conveying roller driving gear 6b are of the same size and configuration; instead, the peeling paper conveying roller 6 is larger in diameter than the platen roller 3.

In the first embodiment, the conveying roller driving gear 6b is smaller in diameter than the platen roller driving gear 3b and the rpm of the peeling paper conveying roller 6 is larger than that of the platen roller 3, whereby the conveying capacity of the peeling paper conveying roller 6 becomes large. According to this embodiment, in contrast, while the conveying roller driving gear 6b is of the same diameter as the platen roller driving gear 3b and the rpm of the peeling paper conveying roller 6 and the rpm of the platen roller 3 are equal to each other, the peeling paper conveying roller 6 is larger in diameter than the platen roller 3 and hence the peripheral speed of the conveying roller driving gear 6b is high. As a result, the conveying capacity of the peeling paper conveying roller 6 is large in this embodiment as well.

As for the construction other than that described above and the adhesive label manufacturing method, the second embodiment is identical to the first embodiment and provides the same effects as those described above, and hence detailed description thereof is omitted.

It should be noted that the conveying capacity of the peeling paper conveying roller 6 maybe made larger than the conveying capacity of the platen roller 3 by using a method different from those of the first and second embodiments. Further, the constructions of the peeling mechanism and the one-way clutch mechanism are not limited to those of the two embodiments described above but may be subject to various modifications.

While the foregoing description is directed to the case of the continuous label sheet 1 consisting of the large number of the adhesive labels 1a temporarily adhered to the single peeling paper 1b, this should not be construed restrictively. For example, the continuous label sheet 1 may also be constructed such that a single adhesive label is temporarily adhered to a single peeling paper. In that case, the adhesive label that has been peeled off may be cut at suitable positions with a cutter member or the like to thereby obtain a large number of adhesive labels.

Further, the present invention is applicable not only to a label printer having the thermal head 4 but also to a variety of apparatuses having a label conveying apparatus adapted to peel off the adhesive label 1a as it conveys the continuous label sheet 1.

What is claimed is:

1. A label conveying apparatus comprising:
a platen roller for conveying a continuous label sheet, the continuous label sheet comprising an adhesive label temporarily adhered to a continuous-sheet-like peeling paper;
a peeling mechanism for peeling off the adhesive label from the peeling paper; and
a peeling paper conveying roller to which torque from the platen roller is transmitted, for conveying the peeling paper from which the adhesive label has been peeled off by the peeling mechanism at a conveying capacity larger than a conveying capacity of the platen roller.

2. A label conveying apparatus according to claim 1, wherein the peeling paper conveying roller conveys the continuous label sheet at a conveying capacity allowing the continuous label sheet being conveyed to be constantly applied with a force acting to pull the continuous label sheet toward a downstream side in a conveying direction.

3. A label conveying apparatus according to claim 1, wherein the torque is transmitted from the platen roller to the peeling paper conveying roller through gears meshing with each other.

4. A label conveying apparatus according to claim 1, wherein the gears through which the torque is transmitted from the platen roller to the peeling paper conveying roller comprise an accelerating wheel train.

5. A label conveying apparatus according to claim 1, wherein the peeling paper conveying roller is larger in diameter than the platen roller.

6. A label conveying apparatus according to claim 1, wherein the peeling paper conveying roller comprises a one-way clutch mechanism allowing the peeling paper conveying roller to rotate only in a conveying direction of the peeling paper.

7. A label conveying apparatus according to claim 1, wherein as the continuous label sheet comprising a plurality of the adhesive labels temporarily adhered to the peeling paper while being arranged side by side in the conveying direction is supplied, the peeling mechanism successively peels off the plurality of the adhesive labels from the peeling paper.

8. A label printer comprising:
the conveying apparatus as claimed in claim 1; and
a recording head that sandwiches the continuous label sheet between the recording head and the platen roller, for performing recording on a non-adhesive surface of the adhesive label.
